(19) United States
(12) Patent Application Publication
(10) Pub. No.: US 2014/0242971 A1
(43) Pub. Date: Aug. 28, 2014

(54) ACCESS AND CUSTOMIZATION OF A MOTOR VEHICLE BY TELEPHONE

(71) Applicants: Fabrice Aladenize, Bruyeres Le Chatel (FR); Julie Bernard, Paris (FR); Herve Drezet, Boulogne Billancourt (FR); Daniel Ruston, Gif-sur-Yvette (FR)

(72) Inventors: Fabrice Aladenize, Bruyeres Le Chatel (FR); Julie Bernard, Paris (FR); Herve Drezet, Boulogne Billancourt (FR); Daniel Ruston, Gif-sur-Yvette (FR)

(73) Assignee: RENAULT S.A.S., Boulogne-billancourt (FR)

(21) Appl. No.: 14/119,101

(22) PCT Filed: May 16, 2012
(86) PCT No.: PCT/FR2012/051111

§ 371 Date: Apr. 15, 2014

(30) Foreign Application Priority Data
May 20, 2011 (FR) 1154420

(51) Int. Cl. G07C 9/00; H04W 88/06; H04W 4/00

(52) U.S. Cl. CPC G07C 9/00182; H04W 4/008; H04W 88/06; G07C 2009/00206; G07C 2009/00269; G07C 2009/00261; G07C 2009/00198
USPC 455/420; 455/418; 455/552.1

(57) ABSTRACT

Method for accessing a motor vehicle (1), characterized in that it comprises the following steps:—establishment of a contactless communication (20) at very short range between a communicating mobile device (10) and a first contactless reader (2) of the motor vehicle disposed near the outside surface of the motor vehicle (1);—communication of an opening key from the communicating mobile device to the first contactless reader (2);—recognition of the key and actuation of at least one door (3) of the motor vehicle (1) so as to open it and allow entry to the motor vehicle.

The present invention relates to an access method and system, particularly suitable for locking and/or unlocking a motor vehicle. It relates also to a motor vehicle and a communicating mobile device, such as a cell phone, suitable for implementing the access method according to the invention.

Document U.S.2006157563 describes a solution for accessing a motor vehicle via a chip card. For this, a user has an identifier in chip card form which contains a virtual key. Each motor vehicle includes a telematics unit intended to set up a long range communication. When a user moves his or her chip card toward a motor vehicle, a chip card reader of the vehicle recovers the identity of the user. This identity is verified by the central server, either in real time or in an anticipated manner, which transmits an access authorization to the telematics unit of the vehicle. In this solution, any authorization originates from a central server and there is necessarily a telematics unit which communicates at long range with a central server to obtain the necessary authorizations. This presents the drawback of a complex system and a constraint linked to the need for the vehicle always to be within the coverage of the wireless network enabling it to communicate with the central server. Furthermore, implementing a telematics unit in a motor vehicle represents a significant constraint in terms of bulk.

Document FR2801994 describes a second solution for accessing a motor vehicle which relies on the use of a cell phone by a user. In this document, the access to a vehicle is still obtained through a long range communication with a central server via the cell phone, which transmits an authorization to the vehicle via the cell phone, after having verified the identity of the user and of the motor vehicle. In these communications, a long range communication between a telematics unit of the motor vehicle and a central server is mandatory, possibly performed via the cell phone which serves as intermediary. Furthermore, this solution then requires the presence of a fixed physical key in the vehicle for it to be started. A possible short range communication is set up between the cell phone and a unit of the motor vehicle, according to a short range communication technology of a few meters, which makes it possible to act as relay for this unit to communicate with the central server. This solution remains complex and cumbersome to manage since it still requires a long range communication to be set up with a central server.

Also, these two solutions of the prior art are designed for the management of a fleet of motor vehicles, offered for example by self service or by rental to users. They therefore also address the constraints of potential multiple users for a given vehicle. They remain no less complex.

Thus, there is a need to simplify the management of access to a motor vehicle, as well as a solution suited to managing a fleet of motor vehicles.

To this end, the invention relies on a method for accessing a motor vehicle, characterized in that it comprises the following steps:
setting up a contactless communication at very short range between a communicating mobile device and a first contactless reader of the motor vehicle arranged in proximity to the outer surface of the motor vehicle;
communicating an opening key from the communicating mobile device to the first contactless reader;
recognizing the key and actuating at least one door of the motor vehicle to open it and allow entry into the motor vehicle.

The method for accessing a motor vehicle may comprise the following steps:
setting up a contactless communication at very short range between a communicating mobile device and a second contactless reader of the motor vehicle;
communicating a starting key from the communicating mobile device to the second contactless reader;
recognizing the starting key of the motor vehicle.

The method for accessing the motor vehicle may comprise the following steps:
setting up a contactless communication at very short range between a communicating mobile device and the first contactless reader of the motor vehicle arranged in proximity to the outer surface of the motor vehicle;
communicating a locking key from the communicating mobile device to the first contactless reader;
recognizing the actuation key of the doors of the motor vehicle to lock them and prevent entry into the motor vehicle.

The method for accessing a motor vehicle may comprise the following steps:
setting up a contactless communication at very short range between a communicating mobile device and a contactless reader of the motor vehicle arranged on board the motor vehicle;
communicating at least one customization datum of the motor vehicle from the communicating mobile device to the contactless reader;
transmitting the at least one customization datum to a computer of the motor vehicle and modifying at least one parameter of the motor vehicle according to the at least one datum.

The method for accessing a motor vehicle may comprise the transmission of all or some part of the following customization data:
data characteristic of a visual internal ambience of the motor vehicle, such as a parameterization of a human-machine interface of an onboard computer;
data characteristic of a sound internal ambience of the motor vehicle, such as pieces of music, radio choices, sound settings, etc.;
morphological and ergonomic data enabling settings to be implemented, such as the setting of at least one seat, of the rearview mirrors, of the position of the steering wheel, etc.;
navigation preferences data, such as a guiding voice, preferred destinations, etc.;
address book and telephone number data;
setting data for heat comfort, ion and scent generator, etc.;
haptic setting data for certain commands.

The method for accessing a motor vehicle may comprise the setting up of a contactless communication at very short range less than or equal to 10 centimeters and at a frequency of 13.56 MHz between a cell phone and a contactless reader of the motor vehicle.

The method for accessing a motor vehicle may comprise the setting up of a long range telephone communication with a central server to exchange an opening and/or locking and/or starting key, and/or at least one customization datum.

The method for accessing a motor vehicle may comprise the setting up of a long range telephone communication with a central server for a location of a motor vehicle of a fleet, a payment, the exchange of data specific to the motor vehicle such as a level of charge, a fuel level, the pressure of the tires, the mileage, the GPS position, an oil change interval, a diagnosis of the computers, a log of the vehicle stresses for maintenance, a trip completed, with corresponding mileage, the initial and final GPS positions, the fuel consumption.

The invention also relates to a motor vehicle, characterized in that it comprises at least two contactless readers suitable for contactless communication at very short range for the transmission of at least one opening/locking key of at least one door and of a starting key.

The motor vehicle may comprise at least one first contactless reader on a door of the motor vehicle suitable for opening and/or locking the door and/or a second contactless reader on the dashboard of the motor vehicle suitable for starting and/or customizing the motor vehicle.

The motor vehicle may comprise a computer suitable for modifying the configuration of the motor vehicle according to at least one customization datum read by a contactless reader.

The motor vehicle may comprise a computer suitable for transmitting vehicle mileage and/or position and/or customization and/or status data to a communicating mobile device.

The motor vehicle may comprise a human-machine interface for a user to input customization data.

The invention also relates to a communicating mobile device such as a cell phone, characterized in that it comprises a device for contactless communication at very short range and a computer for implementing the method for accessing a motor vehicle as described previously.

The invention relates also to a system for accessing a motor vehicle, characterized in that it comprises at least one motor vehicle as described previously and at least one communicating mobile device as described above.

These objects, features and advantages of the present invention will be explained in detail in the following description of a particular embodiment given as a nonlimiting example in relation to the appended figures in which:

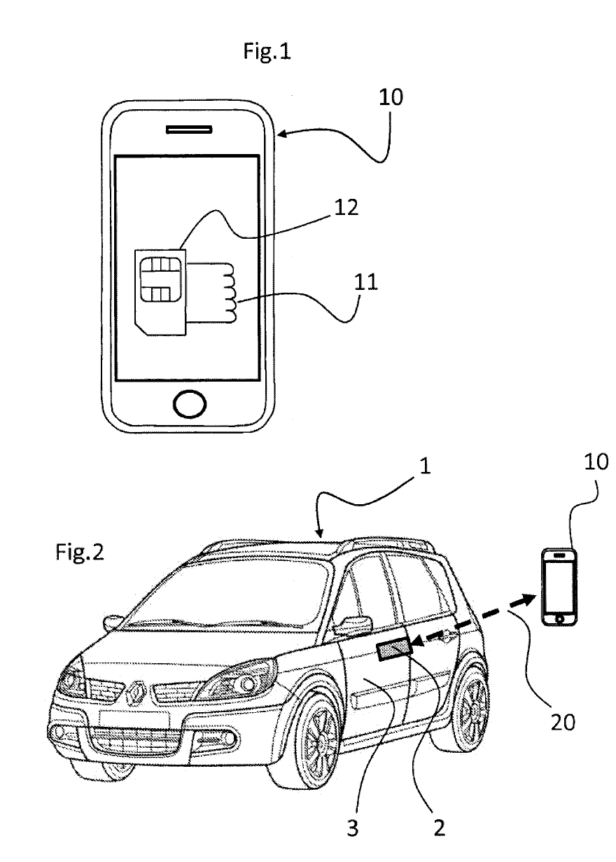

FIG. 1 represents a simplified view of a communicating mobile device of a vehicle access system according to one embodiment of the invention.

FIG. 2 schematically represents the access to a motor vehicle according to the embodiment of the invention.

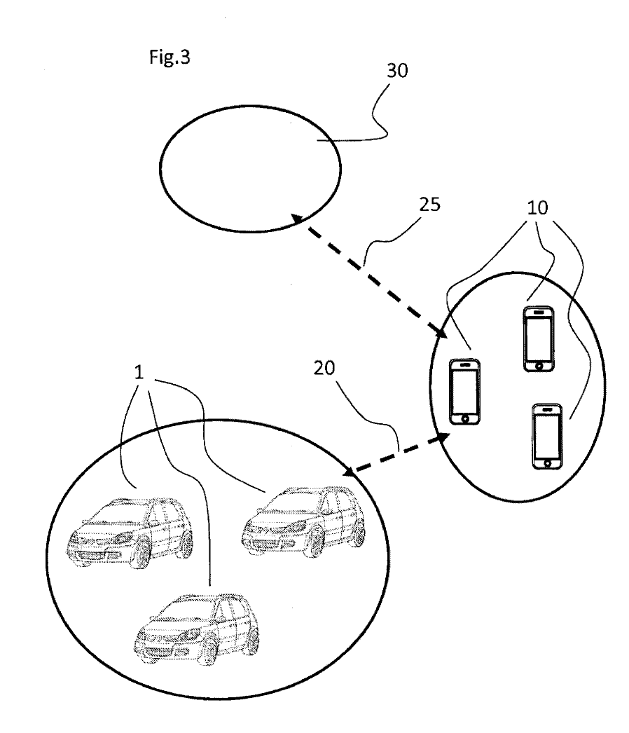

FIG. 3 represents a fleet of motor vehicles accessible according to the embodiment of the invention and managed centrally.

The solution retained proposes accessing a motor vehicle via a communicating mobile device equipped with a very short range contactless communication device, as will be detailed hereinbelow. The description that follows takes a cell phone as an example. The concept can naturally be applied to any communicating mobile device, such as a tablet, a PDA, an Ipod, for example equipped with a communication means of NFC type.

FIG. 1 schematically illustrates a communicating mobile device 10 equipped with the usual components for fulfilling the long range wireless communication function, that is to say allowing for radio frequency communication according to the current standards, such as the GSM, CDMA, EDGE, UMTS, WIFI, Wimax and other such standards. In this embodiment, the communicating mobile device is a telephone 10 which is equipped with a contactless communication device comprising a resonant circuit adapted to exchange data contactlessly with a motor vehicle 1 via a contactless link 20, as represented in FIG. 2, according to a method which will be detailed hereinbelow.

In one embodiment, the resonant circuit is obtained by an inductance antenna 11 connected to the SIM card 12 of the telephone allowing the sensitive data to be stored securely in the chip of the SIM card. As a variant, these data could be stored on any other secure memory, such as, for example, a memory associated with the battery of the telephone 10. The antenna 11 is associated with a capacitor, not represented, to form an oscillating circuit with a different resonance frequency to the frequency used for the telephone communication. The resonant circuit of the telephone, and in particular its antenna 11, is designed for communication at short range and at a particular frequency distant from the long range communication frequency.

FIG. 2 represents a motor vehicle 1 in which the driver's door 3 is equipped with a contactless reader 2. This contactless reader 2 comprises a resonant circuit matched to that of the telephone 10, which can emit an electromagnetic field. Thus, such an electromagnetic field created by a contactless reader 2 induces an electrical current in the antenna 11 of the telephone 10, its remote power feed, which is exploited to implement a transmission of data from the motor vehicle 1 of the telephone 10 and vice versa, by a contactless communication 20, so-called to contrast with the links which require a physical electrical contact via an electrical connecter.

According to the embodiment, the resonant circuits of the contactless reader 2 and of the telephone 10 have physical characteristics, notably their respective inductances and capacitances, so as to form oscillating circuits which resonate at the same resonance frequency, in a radio frequency domain. According to the preferred embodiment, this radio frequency corresponds to a standardized communication at a frequency of 13.56 MHz, according to the technology known by its name NFC (Near Field Communication), and at very short range, less than or equal to 10 centimeters. As a variant, it can consist of any other contactless communication at a frequency similarly allowing for a contactless communication at short range. In FIG. 2, the distance between the telephone 10 and the contactless reader 2 of the motor vehicle is deliberately exaggerated to improve the legibility of the figure.

This contactless communication 20 is naturally exploited for the opening and/or locking of the door 3. According to the embodiment, the motor vehicle is also equipped with a second contactless reader on its dashboard, not represented, which allows for a second contactless communication with the telephone 10 in order to implement the starting of the engine driving the motor vehicle. In these communications, the telephone 10 has at least one key which makes it possible, by a cryptography algorithm, to obtain a secure authentication from a computer of the motor vehicle associated with the contactless reader 2 concerned, to trigger an actuator for opening or locking one or more of the doors or for starting the motor vehicle. For this, the contactless readers of the motor vehicle 1 therefore cooperate with a computer of the vehicle, its onboard computer, for example, for the management of the access methods and other operations linked to the exchange of data with a cell phone 10. As a variant, the motor vehicle could comprise a different number of contactless readers, such as an additional contactless reader on the passenger door and/or on any surface of the motor vehicle accessible from outside, and a different positioning, such as, for example, on the steering wheel or under the windshield. To sum up, the vehicle comprises at least one contactless reader on its outer surface accessible from outside the motor vehicle and at least one other inside the passenger compartment.

In the embodiment chosen, the contactless communication device of the telephone is not powered, not linked to the battery of the telephone, but receives remote power feed from the contactless reader(s) of the motor vehicle, which are, by contrast, powered by the onboard battery of the motor vehicle. This makes it possible to implement the method for accessing a motor vehicle even when the battery of the telephone is discharged. This also allows the telephone to be used when switched off, which behaves passively as an electronic key. As a variant, the resonant circuit of the telephone 10 receives an electrical power feed via the battery of the telephone.

The above description therefore relates to a method for accessing a motor vehicle which comprises the following steps:
setting up a contactless communication at very short range between a cell phone and a first contactless reader of a motor vehicle arranged in proximity to the outer surface of the motor vehicle;
communicating an unlocking key from the cell phone to the first contactless reader;
recognizing the unlocking key and actuating at least one door of the motor vehicle to open it and allow entry into the motor vehicle.

The reverse steps make it possible to lock the doors of the motor vehicle.

In addition, the method for accessing a motor vehicle comprises the following additional steps:
setting up a contactless communication at very short range between a cell phone and a second contactless reader of the motor vehicle arranged in proximity to the dashboard of the motor vehicle;
communicating a starting key from the cell phone to the second contactless reader;
recognizing the starting key and starting the motor vehicle.

The solution described previously offers the advantage of implementing the access to a motor vehicle in a simple, user-friendly and secure manner. Each user generally has a cell phone and its use to access his or her vehicle makes it possible to avoid having a separate key dedicated to the motor vehicle. It should be noted that the different locking, unlocking and starting keys mentioned above may be combined as a single key or may be different.

The cell phone also comprises a computer and software and/or hardware means for implementing the steps of the method for accessing a motor vehicle, as defined above, in cooperation with its contactless communication device.

The use of a telephone offers additional advantages, and one variant of the embodiment of the invention consists in exploiting this telephone to manage additional sensitive personal data such as motor vehicle customization data.

In practice, according to this variant, the telephone also stores, on a secure memory, which can be on the chip of the SIM card 12, different vehicle customization data. This notably makes it possible to change vehicles, to share one and the same vehicle between several people, while being able to retrieve certain selected comfort aspects of the vehicle during any use, to have the agreeable and reassuring sensation of being in one's own vehicle, ideally configured. Furthermore, the use of the same device to access a vehicle, start it, and obtain its customization is a very user-friendly solution.

For this, the following data can be stored on the telephone of a user:
data characteristic of a visual internal ambience of the motor vehicle, such as a parameterization of a human-machine interface of an onboard computer. This parameterization may consist of a parameterization of character strings, of images, of graphic animation, videos, colors, etc.;
data characteristic of a sound internal ambience of the motor vehicle, such as pieces of music, radio choices, sound settings, etc.;
morphological and ergonomic data enabling settings to be implemented, such as the setting of at least one seat, of the rearview mirrors, of the position of the steering wheel, etc.;
navigation preferences, such as a guiding voice, preferred destinations, etc.;
an address book and telephone numbers;
parameters for setting the heat comfort, an ion and scent generator, etc.;
haptic settings for certain commands.

These various customization data are also read by a contactless communication, preferably with one of the contactless readers mentioned, such as the second contactless reader when starting the vehicle or just before starting. The vehicle comprises an onboard computer which uses these customization data to adapt the configuration of the vehicle using these data.

It should be noted that the customization data can be input or modified by a human-machine interface of the motor vehicle, or by an external means. For example, the user can connect his or her telephone 10, or simply his or her SIM card 12, to a computer, via a wired link, via a USB connection, for example, or a wireless link, of Wifi, Bluetooth, or similar type. He or she then inputs his or her customization choices via a human-machine interface of his or her computer and the corresponding data are then transmitted in a predefined format to the user's telephone.

In addition, the user of the access system described previously also makes it possible optionally to implement a motor vehicle management step by storage of data specific to a motor vehicle, including: the level of charge, the fuel level, the pressure of the tires, the mileage, the GPS position, an oil change interval, a diagnosis of the computers, a log of the vehicle stresses for maintenance, etc., as well as items specific to the trip completed, such as the mileage completed, the initial and final GPS positions, the fuel consumption, etc.

Then, these stored data are used in different situations such as: when the same vehicle is next accessed, in another vehicle which can be adapted to take account of these data, the drafting of expense slips, to justify mileage, or personalized insurance, by a fleet manager, etc.

Naturally, the use of a telephone as key presents the advantage of being able to combine the functions described previously with the possibility of performing long range telephone communication. This makes it possible to call a remote server to obtain certain data, such as an access key to a motor vehicle, for example an opening and/or closure and/or starting key, particular information on a particular motor vehicle, such as its GPS position, etc. It is possible to send data from the telephone, such as its customization data in order to make a backup thereof, a number of kilometers traveled, a GPS position, etc. According to one embodiment, this remote communication also presents the advantage of being secured, by authentication methods and/or digital signatures.

It thus appears that the access system and method described previously are particularly suited for implementing a car-sharing solution, in which a number of motor vehicles are shared by a number of users, for example via a manager who has a fleet of motor vehicles, remotely managed via a central server 30, as illustrated in FIG. 3. In this case, a number of users, each having a telephone 10 for accessing a motor vehicle, can remotely purchase a rental of a particular vehicle 1, via telephone communication 25 or via any connection to the central server 30, receive the position of the closest vehicle and its access key or keys.

The user thus accesses the motor vehicle in the manner described previously, is authenticated thereby by his or her telephone, customizes it by his or her telephone to use it as if it were his or her own motor vehicle. It should be noted that this solution is much simpler than the one described in document U.S.2006/0157563, because it does not require any telematics unit in each motor vehicle.

According to another variant embodiment, the contactless reader inside the passenger compartment implements a method for recharging the battery of the cell phone by induction, since said battery is positioned in its proximity for the contactless communication. This makes it possible to leave the telephone in a receptacle facing the reader during a trip to have it recharged during this trip.

The embodiment has been described on the basis of the use of a telephone equipped with a very short range communication device of NFC type. As a variant, or in addition, another portable electronic device, such as a badge, a contactless card, a vehicle key with electronic key head, a personal digital assistant (PDA), can be used to store the access key or keys and/or the customization data.

Furthermore, the embodiment has been described with a motor vehicle, but it could also be implemented to access buildings, or for the use of any other device or object, for example in car sharing.

1. A method for accessing a motor vehicle, said method comprising the following steps:
setting up a contactless communication at very short range between a communicating mobile device and a first contactless reader of the motor vehicle arranged in proximity to the outer surface of the motor vehicle;
communicating an opening key from the communicating mobile device to the first contactless reader;
recognizing the key and actuating at least one door of the motor vehicle to open said door and allow entry into the motor vehicle.

2. The method for accessing a motor vehicle as claimed in claim 1, further comprising the following steps:
setting up a contactless communication at very short range between a communicating mobile device and a second contactless reader of the motor vehicle;
communicating a starting key from the communicating mobile device to the second contactless reader;
recognizing the starting key of the motor vehicle.

3. The method for accessing a motor vehicle as claimed in claim 1, further comprising the following steps:
setting up a contactless communication at very short range between a communicating mobile device and the first contactless reader of the motor vehicle arranged in proximity to the outer surface of the motor vehicle;
communicating a locking key from the communicating mobile device to the first contactless reader;
recognizing the actuation key of doors of the motor vehicle to lock said doors and prevent entry into the motor vehicle.

4. The method for accessing a motor vehicle as claimed in claim 1, further comprising the following steps:
setting up a contactless communication at very short range between a communicating mobile device and a contactless reader of the motor vehicle arranged on board the motor vehicle;
communicating at least one customization datum of the motor vehicle from the communicating mobile device to the contactless reader;
transmitting the at least one customization datum to a computer of the motor vehicle and modifying at least one parameter of the motor vehicle according to the at least one datum.

5. The method for accessing a motor vehicle as claimed in claim 4, further comprising transmitting all or some part of the following customization data:
data characteristic of a visual internal ambience of the motor vehicle, including a parameterization of a human-machine interface of an onboard computer;
data characteristic of a sound internal ambience of the motor vehicle, including pieces of music, radio choices, and sound settings;
morphological and ergonomic data enabling settings to be implemented, including a setting of at least one seat, of the rearview mirrors, and of the position of the steering wheel;
navigation preferences data, including a guiding voice and preferred destinations;
address book and telephone number data;
setting data for heat comfort, ion and scent generator;
haptic setting data for certain commands.

6. The method for accessing a motor vehicle as claimed in claim 1, further comprising setting up a contactless communication at very short range less than or equal to 10 centimeters and at a frequency of 13.56 MHz between a communicating mobile device and a contactless reader of the motor vehicle.

7. The method for accessing a motor vehicle as claimed in claim 1, further comprising setting up a long range telephone communication with a central server to exchange an opening and/or locking and/or starting key, and/or at least one customization datum.

8. The method for accessing a motor vehicle as claimed in claim 7, further comprising setting up a long range telephone communication with a central server for a location of a motor vehicle of a fleet, a payment, the exchange of data specific to the motor vehicle such as a level of charge, a fuel level, the pressure of the tires, the mileage, the GPS position, an oil change interval, a diagnosis of the computers, a log of the vehicle stresses for maintenance, a trip completed, with corresponding mileage, the initial and final GPS positions, the fuel consumption.

9. A motor vehicle, comprising at least two contactless readers suitable for contactless communication at very short range for the transmission of at least one opening/locking key of at least one door and of a starting key.

10. The motor vehicle as claimed in claim 9, further comprising at least one first contactless reader on a door of the motor vehicle suitable for opening and/or locking the door and/or a second contactless reader on the dashboard of the motor vehicle suitable for starting and/or customizing the motor vehicle.

11. The motor vehicle as claimed in claim 9, further comprising a computer for modifying the configuration of the motor vehicle according to at least one customization datum read by a contactless reader.

12. The motor vehicle as claimed in claim 11, further comprising a computer for transmitting vehicle mileage and/or position and/or customization and/or status data to a communicating mobile device.

13. The motor vehicle as claimed in claim 9, further comprising a human-machine interface for a user to input customization data.

14. A communicating mobile device comprises comprising a device for contactless communication at very short range and a computer for implementing the method for accessing a motor vehicle as claimed in claim 1.

15. A system for accessing a motor vehicle, comprising at least one motor vehicle as claimed in claim 9 and at least one communicating mobile device including a device for contactless communication at very short range and a computer for implementing a method for accessing a motor vehicle.
